(19) United States
(12) Patent Application Publication
(10) Pub. No.: US 2017/0017203 A1
(43) Pub. Date: Jan. 19, 2017

(54) Holographic System for Temporary Traffic Management

(71) Applicant: Eyoel Matios, Fort Collins, CO (US)

(72) Inventor: Eyoel Matios, Fort Collins, CO (US)

(21) Appl. No.: 15/211,030

(22) Filed: Jul. 15, 2016

Related U.S. Application Data
(60) Provisional application No. 62/193,134, filed on Jul. 16, 2015.

(51) Int. Cl. G03H 1/22; G03H 1/00

(52) U.S. Cl. CPC G03H 1/22; G03H 1/0005

(57) ABSTRACT

A holographic system for temporary traffic management creates brightly illuminated holographic images, simulating familiar traffic control devices such as an orange cone and a white pillar. The system is comprised of a software application which securely controls a series of holographic projectors. The system improves visibility for traffic control during road construction projects, or at the scene of an emergency. All of the projectors provide tracking devices which are keyed to the user, enabling their recovery when lost or stolen.

### CROSS-REFERENCE TO RELATED APPLICATIONS

This application claims the benefit of U.S. Provisional Application No. 62/193,134, filed Jul. 16, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to emergency highway safety equipment and in particular to a holographic system for temporary traffic management. In the event of an emergency on a remote highway, traffic approaching at a high rate of speed can produce a substantial risk to emergency personnel, and other workers with a duty to respond and resolve the emergency, such as electric utility workers repairing a downed power line or highway workers repairing a lane or guardrail that has been damaged. Also, for ordinary road construction and repair work, laborers are at greater risk under circumstances of limited visibility, increasing the risk that an approaching driver may not see them in time to slow down and avoid an accident. Unfortunately, existing traffic control systems such as the well-known orange cones have proven to be less than perfect, and the result can be serious injuries or even death for these workers. A holographic system for temporary traffic management, which self-illuminates under the secured control of a laptop computer or similar device, would resolve this problem.

### SUMMARY OF THE INVENTION

Accordingly, the invention is directed to a holographic system for temporary traffic management. The system is comprised of a software application which securely controls a series of holographic projectors. The projectors create brightly illuminated holographic images, simulating familiar traffic control devices such as an orange cone and a white pillar. The system improves visibility for traffic control during road construction projects, or at the scene of an emergency. All of the projectors provide tracking devices which are keyed to the user, enabling their recovery when lost or stolen.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of one example of the rectangular projector component of the first exemplary embodiment, displaying the rectangular projector 10, the Flagman Ahead sign image 11, and the top surface 21 of the rectangular projector 10.

FIG. 2 is a front view of one example of the rectangular projector component of the first exemplary embodiment, displaying the rectangular projector 10, the Road Work Ahead sign image 12, and the top surface 21 of the rectangular projector 10.

FIG. 3 is a side view of the cone projector component of the first exemplary embodiment, displaying the cone projector 13 and the cone image 14.

FIG. 4 is a side view of the pillar projector component of the first exemplary embodiment, displaying the pillar projector 16 and the pillar image 17.

FIG. 5 provides a front view of the cone projector barrel component of the first exemplary embodiment, displaying the cone projector barrel 18, the cylinder 18A, the handle 18B, the wheels 18C, and the plate 19.

FIG. 6 provides a side view of the cone projector barrel component of the first exemplary embodiment, displaying the cone projector barrel 18, the cylinder 18A, the handle 18B, the wheels 18C, and the plate 19.

FIG. 7 provides a top view of two examples of the rectangular projector component of the first exemplary embodiment, displaying the rectangular projectors 10, the top surface 21, and the projectors 20.

FIG. 8 provides a top view of the cone projector component of the first exemplary embodiment, displaying the cone projector 13.

FIG. 9 provides a top view of the pillar projector component of the first exemplary embodiment, displaying the pillar projector 16.

FIG. 10 provides a top view of the cone projector barrel component of the first exemplary embodiment, displaying the cone projector barrel 18, the cylinder 18A, the handle 18B, and the wheels 18C.

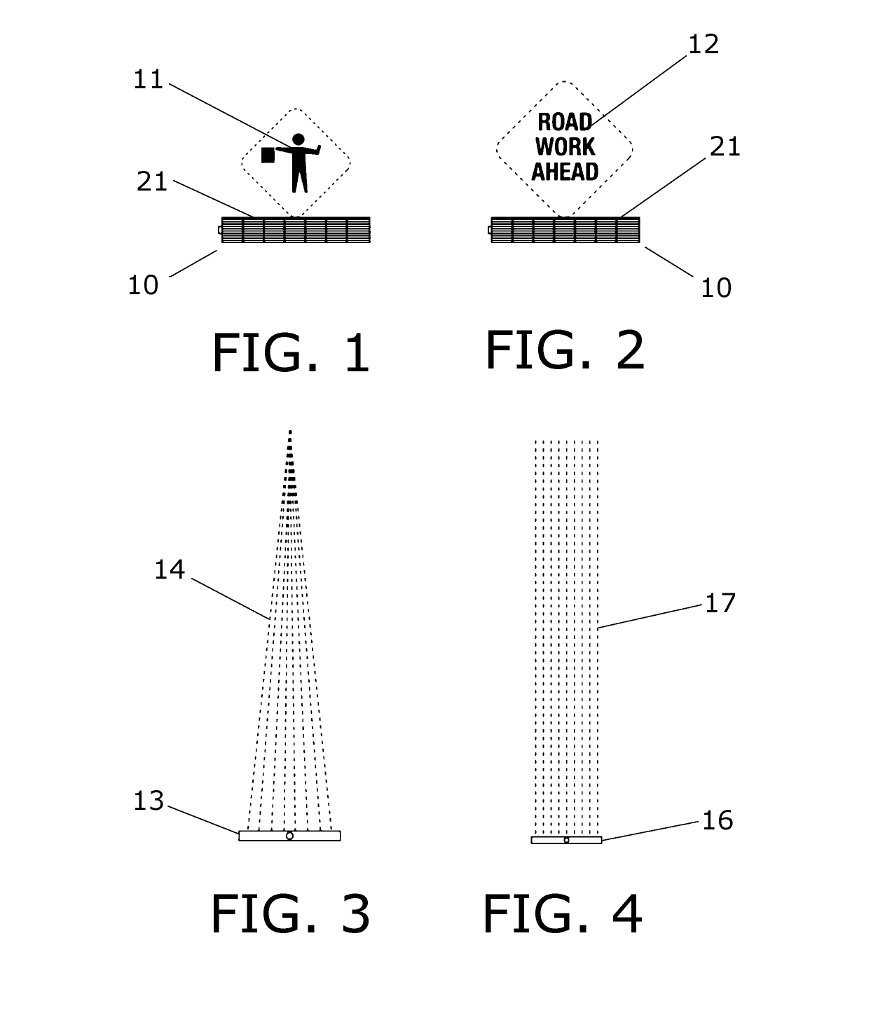

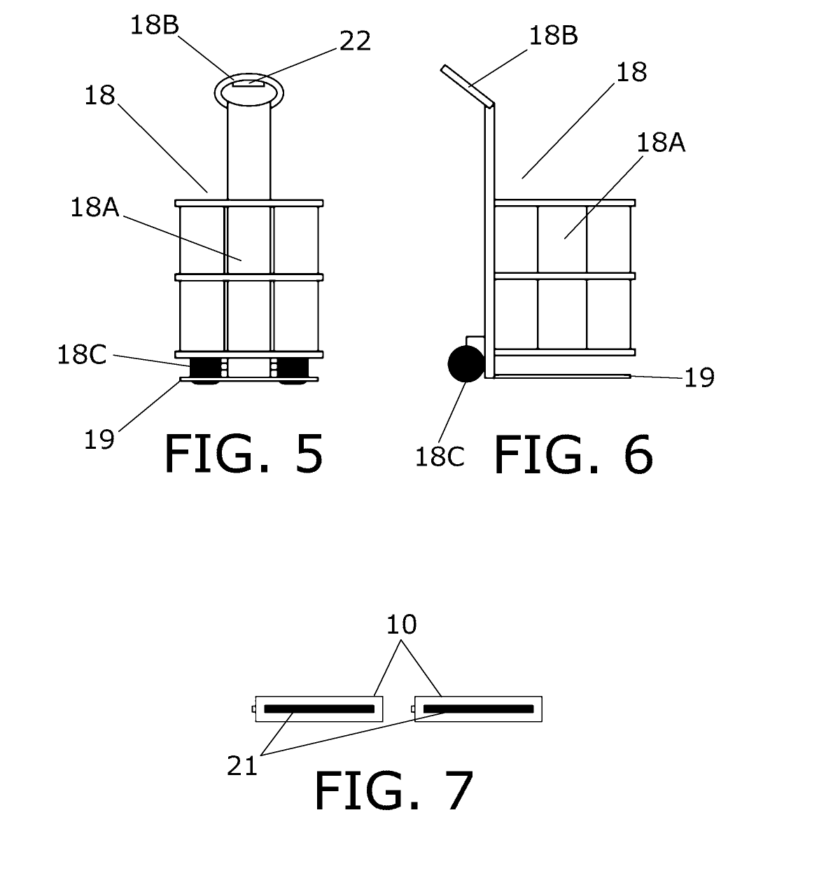

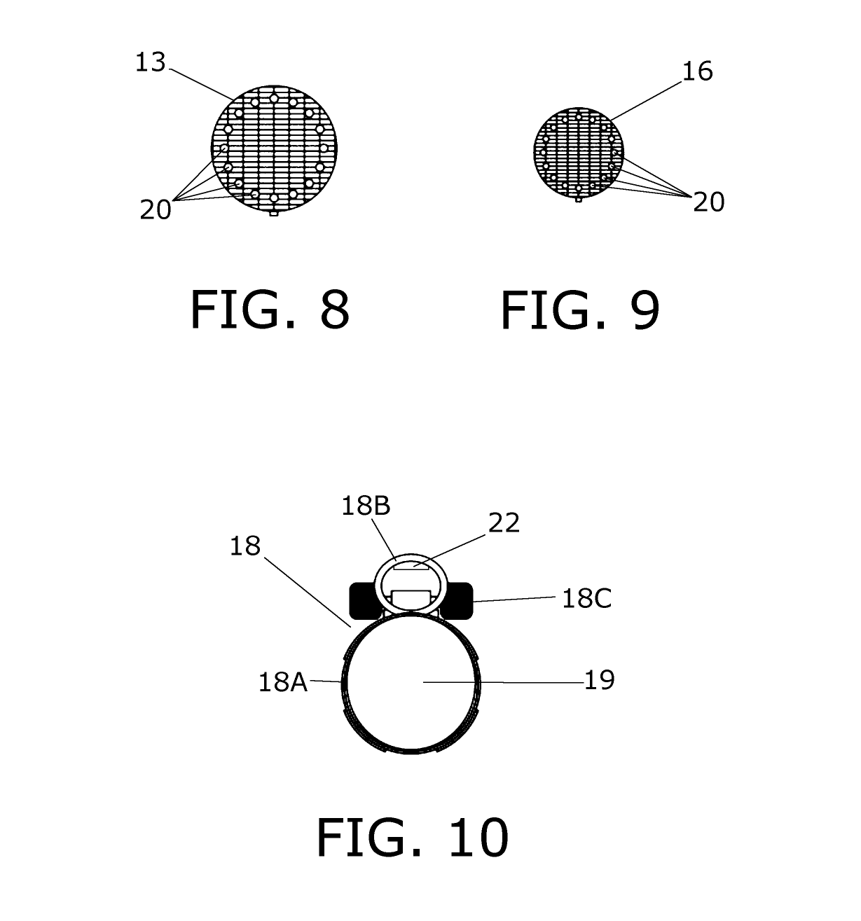

### DETAILED DESCRIPTION OF THE INVENTION

Referring now to the invention in more detail, the invention is directed to a a holographic system for temporary traffic management.

It is to be understood that while the invention is intended for use at road construction sites and emergency scenes, this is not intended as a limitation. With suitable modifications or with no modifications at all, the invention may be used at other locations where temporary, high-visibility traffic control is desired, such as a temporary parking facility.

The first exemplary embodiment is comprised of a series of holographic projectors. The projectors create brightly illuminated holographic images, simulating familiar traffic control devices such as an orange cone and a white pillar. The system improves visibility for traffic control during road construction projects, or at the scene of an emergency.

Each of the projectors provides a tracking device which is keyed to the user, enabling the recovery of the projector in the event it becomes lost or stolen. Each projector also provides a receiver, an internal antenna, a microprocessor and a memory device, enabling secured control of the projector from the user's laptop or other electronic device, either with a password or by some other means. The memory device stores one or more images which may be created by the projector.

The first exemplary embodiment preferably provides three versions of the projectors: a rectangular projector 10, a cone projector 13, and a pillar projector 16. More or fewer versions, as well as different versions, are contemplated. The rectangular projector 10 is preferably 4 inches tall, 4 inches deep, and 36 inches in length, and may be used to project a holographic image out of a holographic projector 21 on the top surface 20. The holographic image may simulate any one of a series of diamond-shaped highway hazard signs, such as a Flagman Ahead sign image 11 or a Road Work Ahead sign image 12. Other sign types and shapes, as well as a variety of languages, are available.

The cone projector 13 creates an orange traffic cone image 14, which is 36 inches in height and 10 inches in diameter at its base. The pillar projector 16 creates a cylindrical white traffic pillar image 17, which is 36 inches in height and 5 inches in diameter. Preferably, both the cone projector 13 and the pillar projector 16 are 0.8 inch (2 centimeters) in height. The top surface 20 of the cone projector 13 provides a series of holographic projectors 21 which are angled slightly inward in order to form a cone where the projected image meets. The top surface 20 of the pillar projector 16 also provides a series of holographic projectors 21. However, the holographic projectors 21 on the pillar projector 16 are directed straight up in the air.

Each projector may be temporarily secured to the roadway surface with a conventional staple gun or any other means of securing an object to the roadway surface. The system provides the advantage of projectors which are much smaller and lighter than the signs or other devices they represent, such that far more may be carried and placed by a service vehicle or by each individual worker. Also, the projectors only need to be placed at the start of a construction project and recovered at the end, regardless of the length of the project, rather than being placed every morning and recovered every evening.

Each projector also provides a rechargeable battery and, optionally, one or more small solar panels. The solar panels actively recharge the battery when they are exposed to sunlight, and the battery may also be recharged using standard household current. A removable adapter and power cord are provided for this purpose. Preferably, a bank recharging device is also available, which provides a sufficient number of outlets to simultaneously recharge the batteries of a large plurality of projectors, such as 40 projectors.

The system also provides a projector barrel 18. The projector barrel 18 provides a vertical cylinder 18A which is open at both ends and may be used to carry a plurality of cone projectors 13 or pillar projectors 16. The projector barrel is sized to have a diameter slightly greater than the projectors (cone 13 or pillar 16) is is meant to carry. The projector barrel may carry up to 10 cone projectors 13. A circular plate 19 is provided, 1 inch below the lower end of the cylinder 18A, with the same diameter as the cylinder 18A, such that any cone projectors 13 or pillar projectors 16 which are carried in the cylinder 18A are stacked on the plate 19. A handle 18B and two small wheels 18C are also provided, such that the cone projector barrel 18 may be moved about in a manner similar to a hand truck.

A trigger 22 is provided on the handle 18B which, when squeezed, ejects a cone projector 13 or pillar projector 16 through the 1-inch slot between the plate 19 and the lower end of the cylinder 18A, using a mechanism which is well known to the art. Thus the user may pull the cone projector barrel 18 using the handle 18B, periodically squeezing the trigger 22, to place an entire row of cone projectors 13.

All of the projectors provide tracking devices which are keyed to the user, enabling their recovery when lost or stolen. These tracking devices are preferably radio frequency (RF) transmitters, but may transmit using any one of several other short-range communications protocols. Each projector provides a metal plate which is stamped with a unique serial number, which is also stored on the memory device. The managing entity of the system, such as the manufacturer, maintains a record of all projectors, their index numbers, and the users who purchased them. In the event that one or more projectors are sold or otherwise transferred from one user to another, the managing entity will provide a single-use digital transfer key, such that the transferred projectors will be keyed to their new owner.

To use the first exemplary embodiment, the user may plug in one or more of the projectors to the bank recharging device to recharge the batteries, and may download and install the application on the user's electronic device. The user then unplugs the projectors, transports the projectors to the desired location, and places each projector in the desired position. The rectangular projectors 10 must be placed by hand, while the cone projector 13 and the pillar projector 16 may optionally be placed with their respective projector barrels. The user may then secure the projectors to the roadway surface using a staple gun or any other suitable means of securing an object to a roadway surface, and may then remotely activate and deactivate the projectors using the electronic device. When the construction project is completed or the emergency has been resolved, the user may easily recover the projectors by pulling them up from the roadway.

Electronic components of the projectors preferably include a rechargeable battery, a memory device, a microprocessor, a receiver, a transmitter, and an internal ring antenna.

The rectangular projector 10, the cone projector 13, the pillar projector 16, the cone projector barrel 18, the pillar projector barrel, and the bank recharging device are preferably manufactured from rigid, durable materials which are corrosion resistant, such as steel, brass, plastic, aluminum alloy, copper alloy, and fiberglass. The wheels 18C are preferably manufactured from a rigid, durable material such as steel or aluminum alloy, with solid tires which are preferably manufactured from a flexible, durable material such as rubber or silicon. The solar panels 16 are preferably monocrystalline wafers manufactured from a rigid, durable material capable of photovoltaic effect, such as silicon. The power cords and the recharging cables are preferably manufactured from braided copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A holographic traffic management system, comprising:
a. one or more projectors;
b. said one or more projectors having a top surface;
c. said one or more projectors providing at least one holographic projector on the top surface;
d. said holographic projector being capable of projecting a holographic image above the projector;
e. said one or more projectors individually providing tracking devices such that each projector's location may be tracked remotely;
f. said one or more projectors providing means of being remotely controlled by an external electronic device; and
g. said one or more projectors providing means of storing images such that each projector may display the holographic image above the projector when activated.

2. The holographic traffic management system of claim 1, wherein at least one of said one or more projectors is a rectangular projector; said rectangular projector providing a rectangular prism shape; said rectangular projector being configured to project a holographic image out of the holographic projector on the top surface; said holographic image being a diamond-shaped highway hazard sign.

3. The holographic traffic management system of claim 2, wherein said diamond-shaped highway hazard sign is a flagman ahead hazard sign.

4. The holographic traffic management system of claim 2, wherein said diamond-shaped highway hazard sign is a road work ahead hazard sign.

5. The holographic traffic management system of claim 1, wherein at least one of said one or more projectors is a cone projector; said cone projector providing a short cylindrical shape; said cone projector providing a series of holographic projectors on the top surface; said series of holographic projectors being angled slightly inward such that an orange cone holographic image is created above the cone projector.

6. The holographic traffic management system of claim 1, wherein at least one of said one or more projectors is a pillar projector; said pillar projector providing a short cylindrical shape; said pillar projector providing a series of holographic projectors on the top surface; said series of holographic projectors being directed straight upward such that a white pillar holographic image is created above the pillar projector.

7. The holographic traffic management system of claim 5, further comprising a projector barrel; said projector barrel comprising a hollow vertical cylinder being open at both ends; the hollow vertical cylinder being attached to a handle; two wheels being attached at a bottom end of the handle such that the projector barrel can be rolled; a circular plate being attached to said handle a distance below the hollow vertical cylinder slightly greater than the height of the cone projector; the diameter of the vertical cylinder being slightly greater than the diameter of the cone projector; a trigger; said trigger being configured to eject a single cone projector through the space between the circular plate and the hollow vertical cylinder when pulled.

8. The holographic traffic management system of claim 6, further comprising a projector barrel; said projector barrel comprising a hollow vertical cylinder being open at both ends; the hollow vertical cylinder being attached to a handle; two wheels being attached at a bottom end of the handle such that the projector barrel can be rolled; a circular plate being attached to said handle a distance below the hollow vertical cylinder slightly greater than the height of the pillar projector; the diameter of the vertical cylinder being slightly greater than the diameter of the pillar projector; a trigger; said trigger being configured to eject a single pillar projector through the space between the circular plate and the hollow vertical cylinder when pulled.
